(19) United States
(12) Patent Application Publication
(10) Pub. No.: US 2026/0109276 A1
(43) Pub. Date: Apr. 23, 2026

(54) SAFETY SEAT AND IMPACT SHIELD THEREOF

(71) Applicant: WONDERLAND SWITZERLAND AG, Steinhausen (CH)

(72) Inventors: Daliang ZHANG, Dongguan, Guangdong (CN); Ganqing FANG, Dongguan, Guangdong (CN)

(73) Assignee: WONDERLAND SWITZERLAND AG, Steinhausen (CH)

(21) Appl. No.: 19/123,674

(22) PCT Filed: Nov. 9, 2023
(86) PCT No.: PCT/EP2023/081272

§ 371 Date: Apr. 23, 2025

(30) Foreign Application Priority Data
Nov. 10, 2022 (CN) 202211405993.1

(51) Int. Cl. B60N 2/28

(52) U.S. Cl. CPC B60N 2/2839

(57) ABSTRACT

The present disclosure relates to an impact shield and a safety seat including the impact shield. The impact shield includes a fixed base a movable part, and an adjustment mechanism. The fixed base is adapted to be connected to a seat body of the safety seat. The movable part is movably connected to the fixed base. The adjustment mechanism is arranged between the fixed base and the movable part, and is configured to adjust a position of the movable part relative to the fixed base

### CROSS-REFERENCE TO RELATED APPLICATIONS

The present application claims priority to Chinese patent application No. 202211405993.1, filed with China National Intellectual Property Administration on Nov. 10, 2022. The contents of the above identified Chinese patent application are hereby incorporated in their entireties by reference for all purposes.

### TECHNICAL FIELD

The present disclosure relates to the technical field of child carriers, and more particularly, to safety seats and impact shields thereof.

### BACKGROUND

A traditional safety seat equipped with an impact shield restrains an occupant on the safety seat through the impact shield. In an event of emergency braking, the impact shield can reduce impact force on the occupant tilting forward, and absorb the impact force on the spine and neck to protect the cervical spine. A safety seat with an adjustable impact shield is known. A conventional impact shield is connected to a seat body of the safety seat through a removable connection mechanism, and a position of the impact shield relative to the seat body cannot be adjusted, resulting in that the safety seat has a fixed and nonadjustable seating space. Such a safety seat cannot meet the seating needs of children of different body sizes.

### SUMMARY

A first aspect of the present disclosure provides an impact shield applicable to a safety seat. The impact shield includes a fixed base, a movable part, and an adjustment mechanism. The fixed base is adapted to be connected to a seat body of the safety seat. The movable part is movably connected to the fixed base. The adjustment mechanism is arranged between the fixed base and the movable part, and is configured to adjust a position of the movable part relative to the fixed base.

In the first aspect of the present disclosure, the adjustment mechanism includes a driving unit movably connected to the movable part. The driving unit is rotatably connected to the fixed base to drive the movable part to move, and a rotation axis of the driving unit intersects a moving direction of the movable part.

In the first aspect of the present disclosure, the rotation axis of the driving unit is perpendicular to the moving direction of the movable part.

In the first aspect of the present disclosure, the adjustment mechanism includes a driving unit extending through the movable part and including a rotating shaft and a gear. The gear is fastened to the rotating shaft and arranged coaxially with the rotating shaft, the movable part is provided with a rack configured to be engaged with the gear, and the driving unit is configured to be rotatably connected to the fixed base, so that when the driving unit rotates, the movable part is driven to move relative to the fixed base by the engagement between the gear and the rack.

In the first aspect of the present disclosure, the movable part is provided with a first strip-shaped hole, the rack is arranged on a hole wall of the first strip-shaped hole, and the first strip-shaped hole is configured to allow the gear to rotate in the first strip-shaped hole.

In the first aspect of the present disclosure, the rack is arranged along an arc line or a straight line.

In the first aspect of the present disclosure, the adjustment mechanism includes a locking unit including a locking member. The locking member is engaged with the rotating shaft to rotate in synchronization with the rotating shaft, the locking member is slidable relative to the rotating shaft along a rotation axis of the driving unit, and the locking member is configured to be operable to be selectively disposed at a locked position or an unlocked position along a sliding path. When the locking member is disposed at the locked position, the locking member is restricted from rotating, and when the locking member is disposed at the unlocked position, the locking member is allowed to rotate to drive the rotating shaft to rotate synchronously.

In the first aspect of the present disclosure, the adjustment mechanism includes a locking unit including a locking member, the locking member is engaged with the rotating shaft to rotate in synchronization with the rotating shaft, the locking member is slidable relative to the rotating shaft along a rotation axis of the driving unit, and the locking member is configured to be operable to be selectively disposed at a locked position or an unlocked position along a sliding path. The locking member includes a first engaging portion, and the fixed base is provided with a second engaging portion adapted to be engaged with the first engaging portion. When the locking member is disposed at the locked position, the first engaging portion is engaged with the second engaging portion, and when the locking member is disposed at the unlocked position, the first engaging portion is disengaged from the second engaging portion.

In the first aspect of the present disclosure, the fixed base is provided with a first limiting portion, and the locking member is provided with a second limiting portion. The second limiting portion is configured to cooperate with the first limiting portion to limit a sliding distance of the locking member relative to the movable part in a direction away from the movable part.

In the first aspect of the present disclosure, the adjustment mechanism includes a locking unit comprising a locking member. The fixed base is provided with a fixing hole extends therethrough. At least a part of the locking member is received in the fixing hole. An end of the rotating shaft extends into the fixing hole to be engaged with the locking member. The locking member is provided with an engaging tooth, and an inner wall of the fixing hole is provided with an engaging groove configured to be engaged with the engaging tooth.

In the first aspect of the present disclosure, the locking member includes an annular outer circumferential surface. The engaging tooth is arranged on the outer circumferential surface. The engaging tooth has a rounded edge on both sides in a circumferential direction of the outer circumferential surface.

In the first aspect of the present disclosure, the adjustment mechanism includes a locking unit including a locking member, and the locking member includes an annular outer circumferential surface. A plurality of engaging teeth are arranged at equal intervals on the outer circumferential surface. A plurality of engaging grooves are arranged at equal intervals on the inner wall of the fixing hole. The plurality of engaging teeth are configured to engage with the plurality of engaging grooves respectively.

In the first aspect of the present disclosure, the adjustment mechanism includes a locking unit including a locking member. The fixed base is provided with a fixing hole extends therethrough, at least a part of the locking member is received in the fixing hole, and an end of the rotating shaft extends into the fixing hole to be engaged with the locking member. At least a part of the locking member is shaped as a regular polygonal cylinder. At least a part of an inner wall of the fixing hole defines a regular polygonal hole matching the regular polygonal cylinder.

In the first aspect of the present disclosure, the fixed base is provided with a fixing hole extending therethrough. The adjustment mechanism includes a locking unit including a locking member. The locking member is arranged on a first side surface of the fixed base away from the movable part and positioned outside the fixing hole. An end of the rotating shaft extends through the fixing hole to be engaged with the locking member. The locking member is configured to, when the locking member is disposed at the locked position, abut against or be in snap-fit with the first side surface for locking.

In the first aspect of the present disclosure, engaging grooves, end face teeth, or engaging holes are arranged on the first side surface. Engaging teeth, further end face teeth, or pin shafts which match the engaging grooves, end face teeth, or engaging holes are arranged on a side surface of the locking member facing the first side surface.

In the first aspect of the present disclosure, the adjustment mechanism includes a locking unit including a locking member, the locking member is engaged with the rotating shaft to rotate in synchronization with the rotating shaft, the locking member is slidable relative to the rotating shaft along a rotation axis of the driving unit, and the locking member is configured to be operable to be selectively disposed at a locked position or an unlocked position along a sliding path. The locking unit further includes a first reset member arranged between the fixed base and the locking member or arranged between the movable part and the locking member. The first reset member is configured to bias the locking member toward the locked position.

In the first aspect of the present disclosure, the adjustment mechanism includes a locking unit including a locking member, a first pin shaft and a driving member fixedly connected to the locking member. The locking member is engaged with the rotating shaft to rotate in synchronization with the rotating shaft, and the locking member is slidable relative to the rotating shaft along a rotation axis of the driving unit. One of the rotating shaft and the driving member is provided with a second strip-shaped hole, the other of the rotating shaft and the driving member is fixedly connected to the first pin shaft. The first pin shaft is inserted into the second strip-shaped hole and movable along the second strip-shaped hole.

In the first aspect of the present disclosure, the driving member is provided with a mounting hole arranged in an axial direction of the rotating shaft. An end of the rotating shaft is inserted into the mounting hole and movable in an extending direction of the mounting hole.

In the first aspect of the present disclosure, the adjustment mechanism includes a locking unit including a locking member. The fixed base is provided with a fixing hole extending therethrough, at least a part of the locking member is received in the fixing hole, and an end of the rotating shaft extends into the fixing hole to be movably connected to the locking member. An end of the locking member away from the movable part is provided with an operating portion, and at least a part of the operating portion extends out of the fixing hole.

In the first aspect of the present disclosure, the impact shield includes two fixed bases arranged on both sides of the movable part respectively. Two ends of the rotating shaft are rotatably connected to the two fixed bases on both sides of the movable part, respectively.

In the first aspect of the present disclosure, the adjustment mechanism includes a locking unit. The locking unit includes a locking member and a driving rope. The locking member is movably connected to rotating shaft. Both sides of the movable part are provided with the fixed base and the locking unit. Two ends of the driving rope are connected to the locking members on both sides of the movable part respectively so that the locking members on both sides of the movable part are switchable between a locked position and an unlocked position synchronously.

In the first aspect of the present disclosure, the driving member is provided with a first driving portion and a second driving portion. For the locking unit arranged on one of both sides of the movable part, one of the two ends of the driving rope is connected to the first driving portion of the driving member on the one of both sides of the movable part, and the other of the two ends of the driving rope is connected to the second driving portion of the driving member on the other of both sides of the movable part.

In the first aspect of the present disclosure, the driving member is provided with a mounting hole, a first driving portion arranged outside the mounting hole, and a second driving portion arranged in the mounting hole. An end of the rotating shaft is inserted into the mounting hole. The rotating shaft is provided with a first mounting cavity extending therethrough. The driving rope extends though the first mounting cavity and the mounting hole. One of the two ends of the driving rope is connected to the first driving portion of the driving member on one of both sides of the movable part, and the other of two ends of the driving rope is connected to the second driving portion of the driving member on the other of both sides of the movable part.

In the first aspect of the present disclosure, the driving unit includes at least one driving rod pivotally connected to the movable part and the fixed base.

In the first aspect of the present disclosure, the driving unit includes two driving rods, and each of the two driving rods is pivotally connected to the movable part and the fixed base.

In the first aspect of the present disclosure, the driving unit further includes a second pin shaft. The fixed base includes a first housing and a second housing, the second housing faces the movable part, the first housing and the second housing enclose a receiving cavity, the second housing is provided with a first groove, and the at least one driving rod is arranged in the receiving cavity. An end of the second pin shaft is fastened to the movable part, and another end of the second pin shaft is pivotally connected to the driving rod through the first groove.

In the first aspect of the present disclosure, the first groove has a first groove wall and a second groove wall. The second pin shaft is movable along the first groove and abuts against the first groove wall or the second groove wall to limit a rotation range of the driving rod.

In the first aspect of the present disclosure, the adjustment mechanism includes a locking unit including a locking pin slidably arranged on the movable part and having a locked position and an unlocked position. The fixed base is provided with a plurality of positioning holes. When the locking pin is disposed at the locked position, the locking pin is inserted into one of the plurality of positioning holes, and when the locking pin is disposed at the unlocked position, the locking pin is separated from the positioning hole.

In the first aspect of the present disclosure, the fixed base includes a first housing and a second housing. The second housing faces the movable part. The first housing and the second housing enclose a receiving cavity. The receiving cavity is provided with a raised portion, and the plurality of positioning holes are arranged on the raised portion and extend in a direction parallel to the locking pin. The second housing is provided with a second groove, and when the locking pin is disposed at the locked position, the locking pin is inserted into one of the plurality of positioning holes through the second groove.

In the first aspect of the present disclosure, the adjustment mechanism further includes a locking unit, and an operating unit connected to the locking unit. The operating unit is operable to drive the locking unit to selectively limit or allow a movement of the movable part relative to the fixed base.

In the first aspect of the present disclosure, the adjustment mechanism further includes a locking unit and an operating unit. The operating unit includes: an operating member movably arranged on the movable part; and a driving post slidably connected to the operating member and fixedly connected to the locking pin. The operating member is operable to drive the driving post to move.

In the first aspect of the present disclosure, the operating member is provided with a third strip-shaped hole extending in a direction intersecting with a moving direction of the operating member. The driving post is inserted into the third strip-shaped hole and movable along the third strip-shaped hole.

In the first aspect of the present disclosure, the operating unit further includes a second reset member arranged between the movable part and the operating member. The second reset member is configured to bias the operating member toward an initial position of the operating member where the movable part is fixed relative to the fixed base.

In the first aspect of the present disclosure, the movable part is movable relative to the fixed base along a moving path defined by a first position and a second position higher than the first position. The moving path is curved.

In the first aspect of the present disclosure, the adjustment mechanism includes a locking unit configured to be operable to selectively limit or allow a movement of the movable part relative to the fixed base.

A second aspect of the present disclosure provides a safety seat. The safety seat includes a seat body and the impact shield as described in the first aspect. The impact shield is connected to the seat body through the fixed base.

### BRIEF DESCRIPTION OF THE DRAWINGS

The above and other objects, features and advantages of the present disclosure will become more apparent from a more detailed description of the embodiments of the present disclosure illustrated in the accompanying drawings. Like reference numerals refer to like parts throughout the drawings. The drawings are not intentionally drawn to scale to actual size, the emphasis being on illustrating the gist of the present disclosure.

Other features, objects and advantages of the present disclosure will become more apparent upon reading the detailed description of the non-limiting embodiments with reference to the following drawings.

FIG. 1 is a schematic structural diagram illustrating a safety seat according to a first embodiment of the present disclosure.

FIG. 2 is a side view of the safety seat shown in FIG. 1, with a movable part disposed at a first position.

FIG. 3 is a side view of the safety seat shown in FIG. 1, with the movable part disposed at a second position.

FIG. 4 is a schematic structural diagram illustrating an impact shield in the safety seat shown in FIG. 1.

FIG. 5 is a cross-sectional view of the impact shield shown in FIG. 4, with a locking member disposed at a locked position.

FIG. 6 is an enlarged view of portion A in FIG. 5.

FIG. 7 is a cross-sectional view of the impact shield shown in FIG. 4, with the locking member disposed at an unlocked position.

FIG. 8 is an enlarged view of portion B in FIG. 7.

FIG. 9 is a cross-sectional view of an impact shield in the safety seat shown in FIG. 2.

FIG. 10 is a cross-sectional view of an impact shield in the safety seat shown in FIG. 3.

FIG. 11 is a cross-sectional view of an impact shield according to another embodiment of the present disclosure.

FIG. 12 is a schematic structural diagram illustrating a fixed base of the impact shield shown in FIG. 4.

FIG. 13 is a schematic structural diagram illustrating a locking member and a driving member of the impact shield shown in FIG. 4.

FIG. 14 is a schematic structural diagram illustrating a locking member and a driving member according to another embodiment of the present disclosure.

FIG. 15 is a cross-sectional view of an impact shield according to an embodiment of the present disclosure, with a locking member disposed at a locked position.

FIG. 16 is an enlarged view of portion C in FIG. 15.

FIG. 17 is a partial enlarged schematic view of the locking member of FIG. 15 disposed at an unlocked position.

FIG. 18 is a schematic structural diagram illustrating a first reset member, a driving member and a driving rope of the impact shield shown in FIG. 15.

FIG. 19 is a schematic diagram illustrating a safety seat according to the second embodiment of the present disclosure.

FIG. 20 is a side view of the safety seat shown in FIG. 18, with a movable part disposed at a first position.

FIG. 21 is another side view of the safety seat shown in FIG. 18, with the movable part disposed at a second position.

FIG. 22 is a schematic structural diagram illustrating an impact shield of the safety seat shown in FIG. 18.

FIG. 23 is an exploded view of the impact shield shown in FIG. 22.

FIG. 24 is a schematic structural diagram illustrating a fixed base and a driving rod positioned on a side of the movable part in the impact shield shown in FIG. 21.

FIG. 25 is a schematic structural diagram illustrating the impact shield shown in FIG. 21 with the fixed base and the driving rod removed.

FIG. 26 is a cross-sectional view of the impact shield shown in FIG. 21, with the movable part disposed at the first position and the two driving rods having the same length.

FIG. 27 is another cross-sectional view of the impact shield shown in FIG. 21, with the movable part disposed at the second position and the two driving rods having the same length.

FIG. 28 is yet another cross-sectional view of the impact shield shown in FIG. 21, with the movable part disposed at the first position and the two driving rods having different lengths but the same extending direction.

FIG. 29 is yet further cross-sectional view of the impact shield shown in FIG. 21, with the movable part disposed at the first position and the two driving rods having the same length but different extending directions.

FIG. 30 is still another cross-sectional view of the impact shield shown in FIG. 21, with the movable part disposed at the second position and the two driving rods having the same length but different extending directions.

FIG. 31 is a cross-sectional view of the movable part of the impact shield shown in FIG. 21.

FIG. 32 is a bottom view of the impact shield shown in FIG. 21, with a second base of the movable part removed.

### DETAILED DESCRIPTION

In order to facilitate understanding of the present disclosure, the present disclosure will be described more fully below with reference to the relevant drawings. Preferred embodiments of the present disclosure are shown in the drawings. However, the present disclosure may be embodied in many different forms and is not limited to the embodiments described herein. Rather, these embodiments are provided so that the disclosure of the present disclosure will be thorough and complete.

It should be noted that when an element is referred to as “connected to” another element, it may be directly connected to and integrated with the another element, or an intermediate element may also be present. The terms “mounting”, “an end”, “another end”, and similar expressions used herein are for illustrative purposes only.

Unless otherwise defined, all technical and scientific terms used herein have the same meaning as commonly understood by one of ordinary skill in the technical field to which the present disclosure belongs. The terminology used herein in the description of the present disclosure is for the purpose of describing specific embodiments only and is not intended to limit the present disclosure. As used herein, the term “and/or” includes any and all combinations of one or more of the associated listed items.

In order to make the purpose, technical solutions and advantages of the present disclosure clearer, the present disclosure will be further described in detail below with reference to the drawings and embodiments. It should be understood that the specific embodiments described herein are only used to explain the present disclosure and are not used to limit the present disclosure.

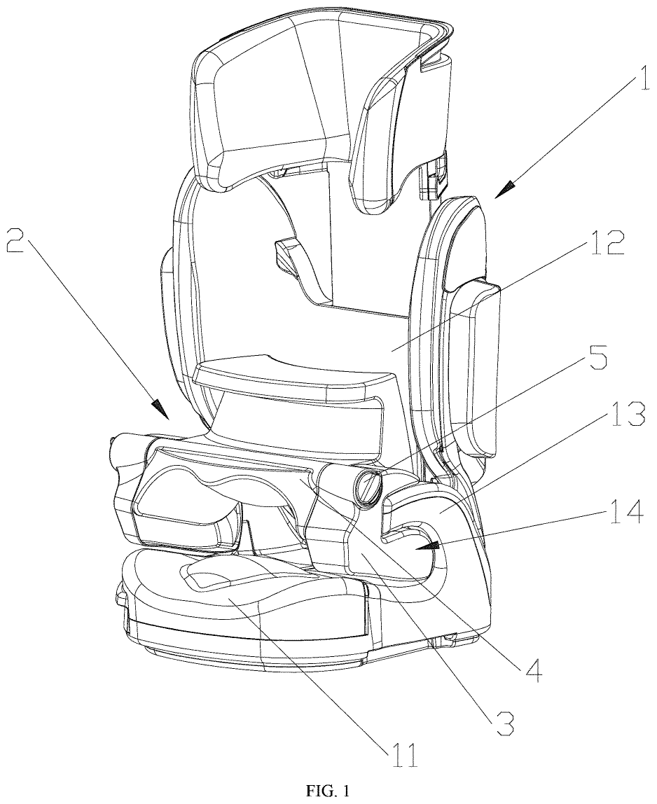

A first embodiment of the present disclosure provides a safety seat applicable for installation in a vehicle, that is, a vehicle safety seat. This safety seat is available for occupants of different body sizes, especially for children. As shown in FIGS. 1 to 4, the safety seat includes a seat body 1 and an impact shield 2. The seat body 1 includes a seat surface 11 and a backrest 12. The impact shield 2 is arranged above the seat surface 11. After the child is placed in the safety seat, the impact shield 2 is removably connected to the seat body 1, and fastened to the seat body 1 through a fixing device such as a safety belt, thereby restraining the child between the seat body 1 and the impact shield 2.

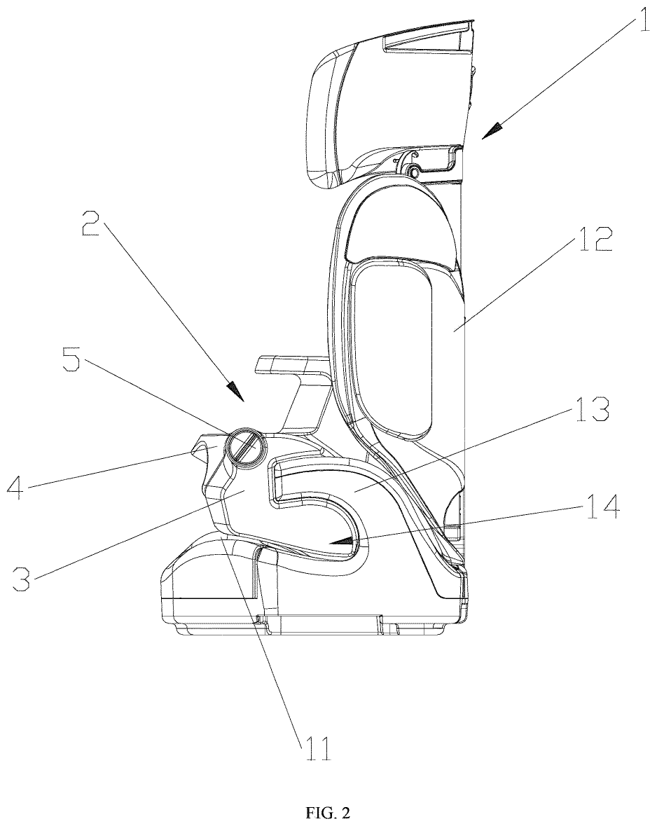

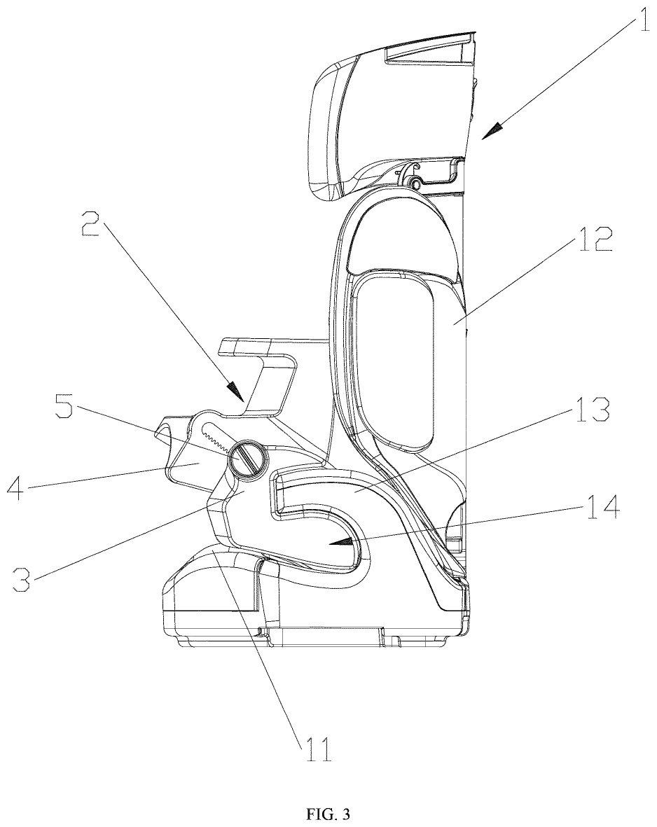

The impact shield 2 includes a fixed base 3, a movable part 4, and an adjustment mechanism 5. In this embodiment, the impact shield 2 is connected to the seat body 1 through the fixed base 3. Specifically, the fixed base 3 is removably connected to the seat body 1. For example, the fixed base 3 is engaged with or inserted into the seat body 1, or connected to the seat body 1 by other means. An engagement groove 14 is formed between the seat surface 11 and an armrest 13 of the seat body 1. The fixed base 3 is removably engaged into the engagement groove 14. The movable part 4 is movably connected to the fixed base 3. The movable part 4 can move relative to the fixed base 3 along a moving path at least defined by a first position (as shown in FIG. 2) and a second position (as shown in FIG. 3). In this embodiment, the second position is higher than the first position. Specifically, the second position is farther from the seat surface 11 than the first position, and the second position is farther from the backrest 12 than the first position.

The adjustment mechanism 5 is arranged between the fixed base 3 and the movable part 4, and is configured to adjust a position of the movable part 4 relative to the fixed base 3. The adjustment mechanism 5 can not only adjust a distance between the movable part 4 and the backrest 12 in a horizontal direction, but also adjust a distance between the movable part 4 and the seat surface 11 in a vertical direction, so that the safety seat has an adjustable seating space, which can better meet the seating needs of children of different body sizes and is convenient for children to use. It should be noted that in this embodiment, the children include infants and young children. The impact shield 2 is not only applicable for the safety seat in this embodiment, but also applicable for infant carry-cots, infant strollers, etc. In this embodiment, when the safety seat is in use, the impact shield 2 is positioned in front of the backrest 12 and above the seat surface 11.

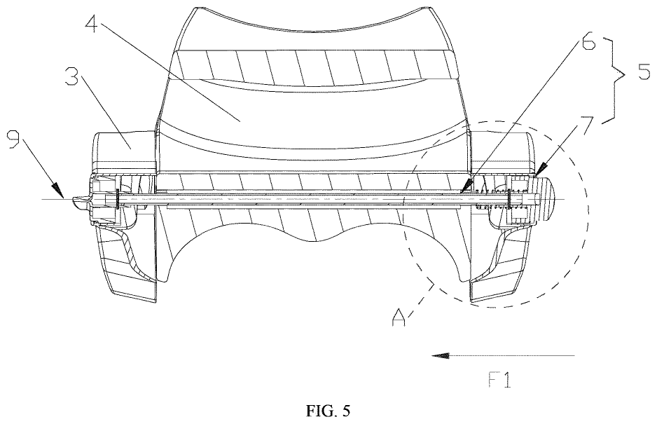

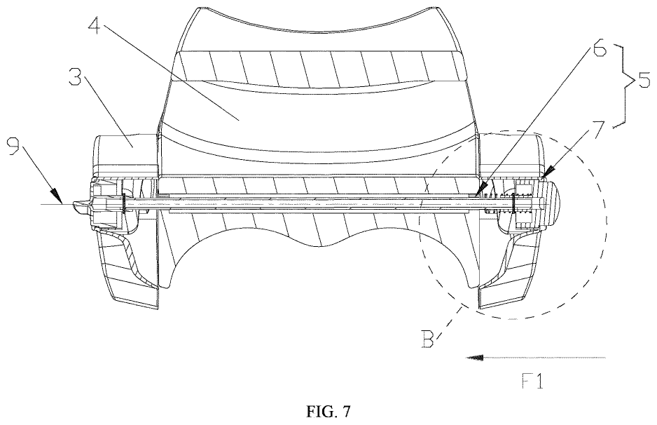

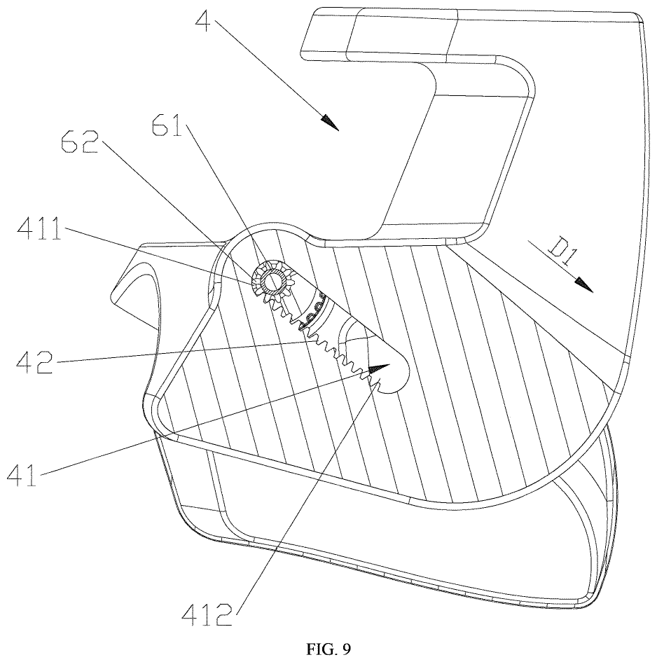

Specifically, as shown in FIGS. 5 to 8, the adjustment mechanism 5 includes a driving unit 6 and a locking unit 7. The driving unit 6 is movably connected to the movable part 4. The driving unit 6 is rotatably connected to the fixed base 3 to drive the movable part 4 to move between at least the first position and the second position. The driving unit 6 has a rotation axis 9 relative to the fixed base 3. The rotation axis 9 intersects with a moving direction of the movable part 4. In this embodiment, the rotation axis 9 is perpendicular to the moving direction (see FIGS. 5 and 9). In other embodiments, the rotation axis 9 of the driving unit 6 relative to the fixed base 3 may not be perpendicular to the moving direction of the movable part 4. For example, an angle formed between the rotation axis 9 and the moving direction may be 80° or 100°, etc.

The locking unit 7 selectively limits or allows the movement of the movable part 4 relative to the fixed base 3. In this embodiment, when the impact shield 2 needs to be adjusted, the locking unit 7 is first unlocked, and the movable part 4 is moved to a desired position through the rotation of the driving unit 6 relative to the fixed base 3. Then, when the locking unit 7 is locked, the rotation of the driving unit 6 relative to the fixed base 3 is restricted, and accordingly, the movement of the movable part 4 relative to the fixed base 3 is restricted, so that the movable part 4 is positioned at the desired position.

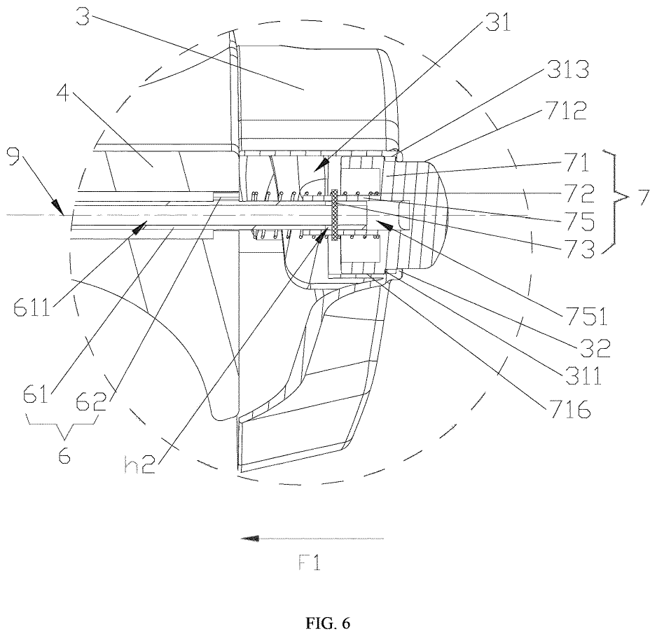

In an embodiment, as shown in FIGS. 5 to 8, the driving unit 6 includes a rotating shaft 61 and a gear 62. The gear 62 is fastened to the rotating shaft 61 and arranged coaxially with the rotating shaft 61. The rotating shaft 61 extends through the movable part 4 and extends out of two opposite side surfaces of the movable part 4. In detail, the movable part 4 has a channel (not labelled) extending from one side surface to the opposite side surface to receive the rotating shaft 61. In addition, as shown in FIG. 6, a fixing hole 31 extends through the fixed base 3. The rotating shaft 61 extends out of the side surface of the movable part 4 and is rotatably connected to the fixed base 3 through the fixing hole 31.

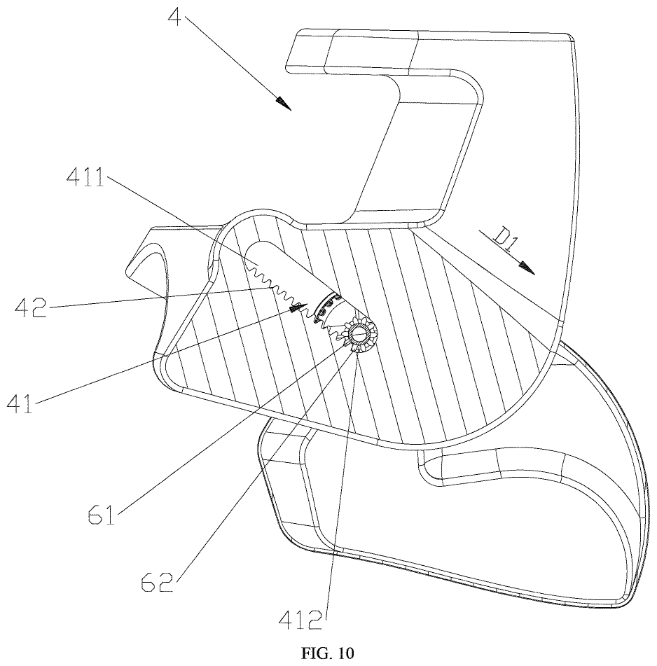

As shown in FIGS. 9 and 10, a first strip-shaped hole 41 is arranged on the side surface of the movable part 4. In this embodiment, two first strip-shaped holes 41 respectively positioned on the two opposite side surfaces of the movable part 4 are connected to each other through the channel. It should be noted that a cross-sectional shape of the channel is not necessarily the same as the cross-sectional shape of the first strip-shaped hole 41. The rotating shaft 61 extends through the first strip-shaped hole 41 and is rotatably connected to the fixed base 3 through the fixing hole 31. A hole wall of the first strip-shaped hole 41 is provided with a rack 42. The first strip-shaped hole is configured to receive the gear 62 and allow the gear 62 to rotate in the first strip-shaped hole 41. The rack 42 is engaged with the gear 62. When the gear 62 rotates, the rack 42 moves relative to the gear 62 to drive the movable part 4 to move relative to the fixed base 3 between at least the first position and the second position.

Specifically, a hole wall of the first strip-shaped hole 41 has a first end 411 and a second end 412. The first end 411 is positioned on a side of the second end 412 away from the seat surface 11. The first end 411 is positioned on a side of the second end 412 away from the backrest 12. As shown in FIG. 9, when the gear 62 is positioned at the first end 411, the movable part 4 is disposed at the first position. As shown in FIG. 10, when the gear 62 is positioned at the second end 412, the movable part 4 is disposed at the second position.

In this embodiment, the rack 42 is arranged on a lower hole wall of the first strip-shaped hole 41. In other embodiments, the rack 42 may also be arranged on an upper hole wall of the first strip-shaped hole 41. On the one hand, through the engagement between the gear 62 and the rack 42 and the rotation of the gear 62 relative to the rack 42, the position of the movable part 4 relative to the fixed base 3 can be adjusted more smoothly. On the other hand, the adjustment achieved through the engagement between the gear 62 and the rack 42 and the rotation of the gear 62 relative to the rack 42 can be approximately infinitely variable adjustment, so that the movable part 4 can be adjusted to any position smoothly.

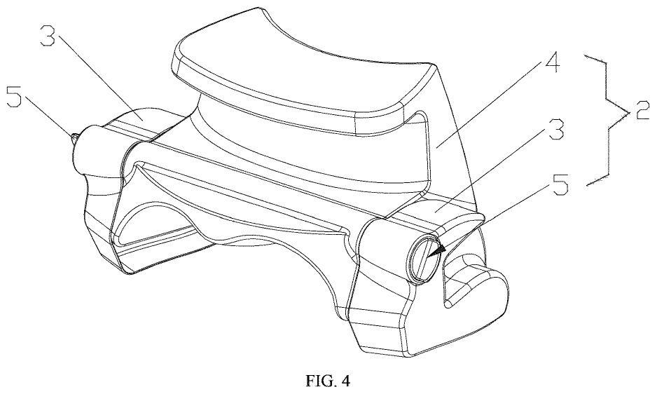

Referring again to FIGS. 4 to 6, in this embodiment, the fixed base 3 is arranged on each of both sides of the movable part 4 so that the impact shield 2 can be more firmly connected to the seat body 1. Both ends of the rotating shaft 61 are rotatably connected to the fixed bases 3 positioned on both sides of the movable part 4. Two gears 62 are arranged on the rotating shaft 61. The first strip-shaped hole 41 is arranged on each of both sides of the movable part 4. The rack 42 is arranged in each of the first strip-shaped holes 41 on both sides of the movable part 4. The two gears 62 are engaged with the racks 42 on both sides of the movable part 4 respectively. The rotating shaft 61 can rotate more stably by rotating the two gears 62 along their respective racks 42 at the same time. In other embodiments, more than two gears 62 may also be provided.

In other embodiments, only a pair of gear 62 and rack 42 engaged with each other may be provided. Alternatively, the first strip-shaped hole 41 may not be provided, and the rack 42 engaged with the gear 62 may be arranged on a lower end surface of the impact shield 2 or arranged on a side surface of the impact shield 2 adjacent to the fixed base 3.

As shown in FIGS. 9 and 10, the first strip-shaped hole 41 extends obliquely relative to a horizontal reference line. In an embodiment, the first strip-shaped hole 41 extends in a direction inclined at an angle of approximately 45 degrees to the seat surface 11. In other embodiments, the angle formed between the first strip-shaped hole 41 and the seat surface 11 may also be greater than 45 degrees or less than 45 degrees. The rack 42 is arranged on the lower hole wall of the first strip-shaped hole 41, so that the gear 62 can move in a first moving direction D1 or a reverse direction of the first moving direction D1. By setting the extending direction of the rack 42, the moving path of the movable part 4 between different positions (for example, between the first position and the second position) can be determined. In this embodiment, the moving path of the movable part 4 between the first position and the second position is linear. Since the rack 42 is arranged on the hole wall of the first strip-shaped hole 41, the moving path of the movable part 4 can be changed by changing the extending direction of the first strip-shaped hole 41.

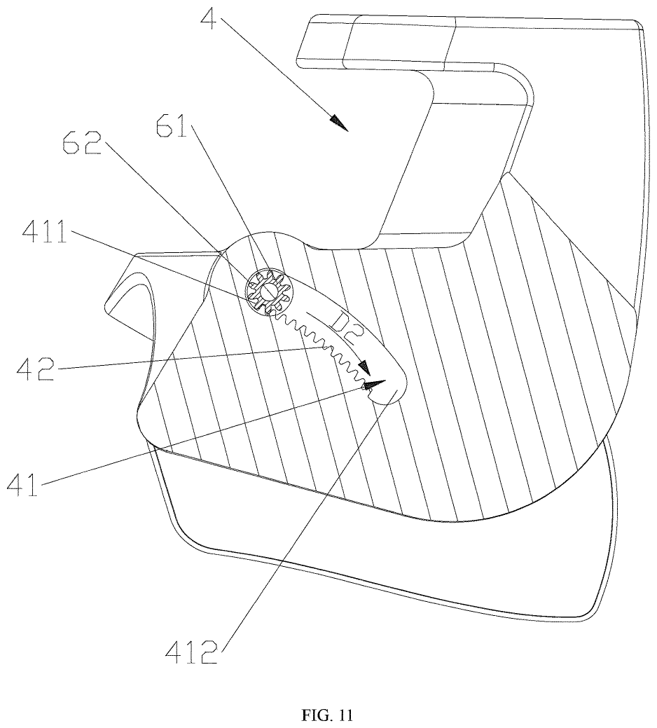

In other embodiments, as shown in FIG. 11, the first strip-shaped hole 41 may also be an arcuate hole, and the rack 42 extends along the arc profile of the arcuate hole and can move in a second moving direction D2 or a reverse direction of the second moving direction D2. Accordingly, in this embodiment, the moving path of the movable part 4 between the first position and the second position is curved. When the gear 62 moves to the first end 411 or the second end 412 along the lower hole wall of the first strip-shaped hole 41, the gear 62 abuts against the hole wall at the first end 411 or the second end 412, to limit the maximum moving range of the gear 62 on the rack 42, without providing additional limiting structures on both sides of the rack 42.

Specifically, as shown in FIGS. 5 to 8, the locking unit 7 includes a locking member 71, a first reset member 72, a first pin shaft (not shown), and a driving member 75. In this embodiment, the locking unit 7 is arranged on the fixed base 3 on each of both sides of the movable part 4. In other embodiments, the locking unit may also be arranged on only the fixed base 3 on one of the sides of the movable part 4.

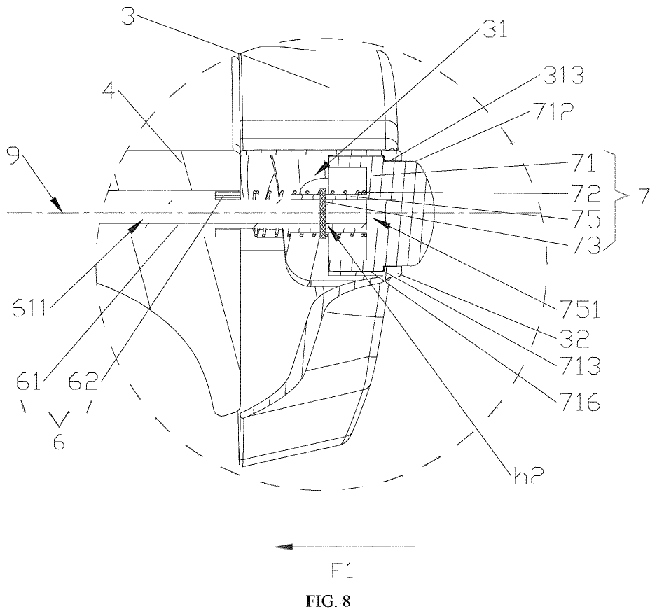

Specifically, as shown in FIGS. 6 and 8, the locking member 71 is at least partially movably arranged in the fixing hole 31. Specifically, as shown in FIGS. 6 and 8, the locking member 71 is engaged with the rotating shaft 61 to rotate in synchronization with the rotating shaft 61. The locking member 71 is slidable relative to the rotating shaft 61 along the rotation axis of the driving unit, and is configured to be operable to be selectively disposed at a locked position or an unlocked position along a sliding path. As shown in FIG. 6, when the locking member 71 is disposed at the locked position, the rotation of the locking member 71 is restricted. Accordingly, the rotation of the rotating shaft 61 relative to the fixed base 3 is restricted. As shown in FIG. 8, the locking member 71 can slide relative to the rotating shaft 61 along the rotation axis of the driving unit and move to the unlocked position. It should be noted that the rotating shaft 61 and the locking member 71 do not rotate relative to each other. That is, when the locking member 71 can be rotated, the rotating shaft 61 can be driven to rotate. Accordingly, when the locking member 71 is disposed at the unlocked position, the locking member 71 is operable to drive the rotating shaft 61 to rotate relative to the fixed base 3.

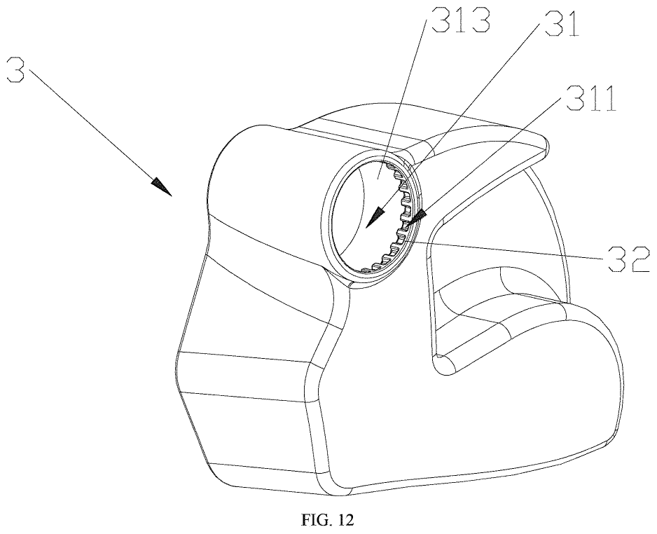

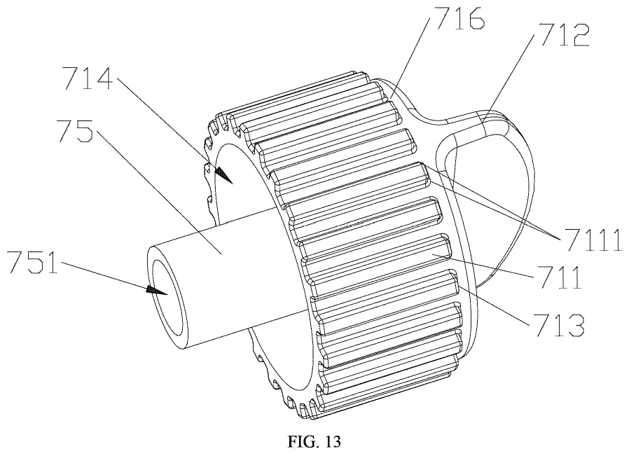

Referring to FIGS. 12 and 13, the locking member 71 in this embodiment is generally in the shape of a cylindrical knob. The locking member 71 has a cylindrical receiving groove 714 arranged in its axial direction. An opening of the receiving groove 714 faces the movable part 4. The locking member 71 is provided with an operating portion 712 on an end surface facing away from the receiving groove 714. In this embodiment, the operating portion 712 is generally in the form of a tab structure perpendicular to the end surface (which faces away from the receiving groove 714) of the locking member 71, and the operating portion 712 at least partially extends out of the fixing hole 31 to facilitate the user operation. In this embodiment, the user can press the locking member 71 in a direction approaching the movable part 4 through the operating portion 712, and rotate the locking member 71 at the same time.

As shown in FIG. 13, the driving member 75 has a substantially cylindrical structure. The driving member 75 is fixed at a substantially middle position of the locking member 71, and extends toward the movable part 4. In this embodiment, the driving member 75 and the locking member 71 are integrally formed. In other embodiments, the driving member 75 and the locking member 71 may also be two separate components, and may be connected to each other by welding, riveting, or the like. As shown in FIG. 8, the driving member 75 is provided with a mounting hole 751 arranged in the axial direction of the rotating shaft 61. An end of the rotating shaft 61 is movably inserted into the mounting hole 751 through the fixing hole 31.

In an embodiment, the rotating shaft 61 may be provided with a second strip-shaped hole h2, and a first pin shaft 73 is fastened to the locking member 71. The first pin shaft 73 is fastened to an inner wall of the mounting hole 751. The first pin shaft 73 is inserted into the second strip-shaped hole h2 and can move along the second strip-shaped hole. The second strip-shaped hole h2 extends parallel to the axial direction of the rotating shaft 61. The second strip-shaped hole h2 may be a through hole or a blind hole. The first pin shaft 73 is inserted into the second strip-shaped hole h2 in a direction perpendicular to the axial direction of the rotating shaft 61. Through inserting and fitting the first pin shaft 73 into the second strip-shaped hole h2, the driving member 75 and the locking member 71 can not only move along the axial direction of the rotating shaft 61, but also rotate in synchronization with the rotating shaft 61. In other embodiments, the first pin shaft 73 may not be arranged perpendicular to the axial direction of the rotating shaft 61, that is, an angle formed between the first pin shaft 73 and the axial direction of the rotating shaft may be greater than 90 degrees or less than 90 degrees. Alternatively, vice versa, the locking member 71 is provided with the second strip-shaped hole h2, and the rotating shaft 61 is provided with the first pin shaft 73 that can be inserted and fitted into the second strip-shaped hole h2.

In other embodiments, the mounting hole 751 may not be arranged on the driving member 75, but may be arranged on the rotating shaft 61 and extend in the axial direction of the rotating shaft 61. The driving member 75 is inserted into the mounting hole 751. Through the first pin shaft 73 extending through the driving member 75 and the second strip-shaped hole h2 arranged on the rotating shaft 61, the rotating shaft 61 can move in the extending direction of the mounting hole 751. Alternatively, the mounting hole 751 may not be arranged on either the driving member 75 or the rotating shaft 61, that is, the driving member 75 is not sleeved on or inserted into the rotating shaft 61, and the driving member may have a protruding portion (not shown) extending toward the movable part 4. The first pin shaft 73 is fastened to the protruding portion, and is movably inserted into the second strip-shaped hole h2 of the rotating shaft.

As shown in FIGS. 12 to 13, the locking member 71 includes a first engaging portion 711, and the fixed base 3 is provided with a second engaging portion 311 adapted to be engaged with the first engaging portion 711. When the locking member 71 is disposed at the locked position (as shown in FIG. 6), the first engaging portion 711 is engaged with the second engaging portion 311. When the locking member 71 is disposed at the unlocked position (as shown in FIG. 8), the first engaging portion 711 is disengaged from the second engaging portion 311.

As shown in FIG. 13, the locking member 71 includes an annular outer circumferential surface 716 surrounding an outer surface of the rotating shaft 61. In this embodiment, the first engaging portion 711 includes a plurality of engaging teeth arranged at equal intervals on the outer circumferential surface 716. The locking member 71 is at least partially provided as an external gear, the teeth of which are formed as engaging teeth. As shown in FIG. 12, the second engaging portion 311 includes a plurality of engaging grooves arranged at equal intervals on an inner wall 313 of the fixing hole 31. The plurality of engaging teeth can be engaged with the plurality of engaging grooves respectively. Specifically, the fixing hole 31 is at least partially formed as an internal gear engagable with the external gear, and gaps between adjacent gear teeth of the internal gear are formed as the engaging grooves.

Through the engagement between the internal gear and the external gear, in combination with the engagement between the gear 62 and the rack 42 and the rotation of the gear 62 on the rack 42, approximately infinitely variable adjustment of the movable part 4 can be achieved. The minimum distance by which the movable part 4 can move depends on the modulus of the gear 62 or the rack 42. In order to ensure that the external gear can still be snapped into the internal gear and engaged with the internal gear after the external gear and the gear 62 rotate synchronously to any extent, the moduli of the internal gear and the external gear are required to be match the modulus of the gear 62 or the rack 42.

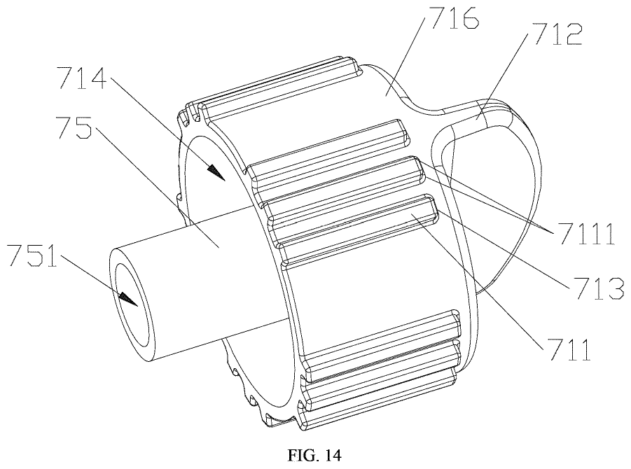

In other embodiments, as shown in FIG. 14, the engaging teeth may also be arranged on only a part of the outer circumferential surface 716. However, in order to rotate the engaging teeth of the locking member 71 in synchronization with the gear 62, and in order that the external gear can still be snapped into the internal gear and mesh with the internal gear after the external gear rotates to any extent in synchronization with the gear 62, a plurality of engaging grooves are arranged at equal intervals on the inner wall 313 of the fixing hole 31. Alternatively, the engaging grooves are arranged on a part of the inner wall 313 of the fixing hole 31, and a plurality of engaging teeth are arranged at equal intervals on the outer circumferential surface 716, so that after the external gear of the locking member 71 rotates to any extent in synchronization with the gear 62, the external gear can still be snapped into the internal gear and engaged with the internal gear. In other embodiments, the first engaging portion 711 may be formed as the engaging groove arranged on the outer circumferential surface 716, and the second engaging portion 311 may be formed as the engaging teeth arranged on the inner wall 313 of the fixing hole 31. But the present disclosure is not limited thereto.

In other embodiments, the first engaging portion 711 may also be in the shape of a regular polygonal cylinder, and at least a part of the inner wall 313 of at least a part of the fixing hole 31 defines a regular polygonal hole that can be engaged with the regular polygonal cylinder to form the second engaging portion 311. Cross-sections of the regular polygonal cylinder and the regular polygonal hole can be in the shape of an equilateral triangle, a regular quadrilateral, a regular hexagon, or the like, and the number of sides of the regular polygon should match the modulus of the gear 62 or the rack 42. The minimum displacement of the movable part 4 can be adjusted by adjusting the number of sides of the regular polygon. When the locking member 71 is disposed at the locked position, the regular polygonal cylinder is engaged with the regular polygonal hole. The operating portion 712 can be pressed or pulled to drive the locking member 71 to move along the rotating shaft 61 in a direction away from the fixing hole 31, so that the regular polygonal cylinder is separated from the regular polygonal hole. In this case, the operating portion 712 is rotated to rotate the rotating shaft 61 to drive the gear 62 to rotate on the rack 42.

In other embodiments, the locking member 71 may also be arranged on the side of the fixed base 3 away from the movable part 4, and positioned outside the fixing hole 31. A side surface of the fixed base 3 away from the movable part 4 is assumed as a first side surface. When the locking member 71 is disposed at the locked position, the locking member 71 can abut against or be in snap-fit with the first side surface to achieve the locking. Alternatively, the second engaging portion 311 may be formed as engaging grooves, end face teeth, or engaging holes arranged on the first side surface, and the first engaging portion 711 may be formed as engaging teeth, further end face teeth, or pin shafts arranged on a side surface of the locking member 71 facing the first side surface. When the locking member 71 is disposed at the locked position, the second engaging portion 311 on the first side surface is engaged with or in snap-fit with the first engaging portion 711 on the locking member 71. In this case, the operating portion 712 can be pulled to drive the locking member 71 to move along the rotating shaft 61 in the direction away from the movable part 4, so that the first engaging portion 711 and the second engaging portion 311 are unlocked. At the same time, the operating portion 712 is rotated to rotate the rotating shaft 61 to drive the gear 62 to rotate on the rack 42.

Further, as shown in FIGS. 13 and 14, the engaging tooth has rounded edges 7111 on both sides in the circumferential direction of the outer circumferential surface 716, so that the engaging tooth can be guided into the corresponding engaging groove. In this way, even if the engaging tooth is not fully engaged with the engaging groove initially, it only needs to move the movable part 4 slightly to make the locking member 71 follow the rotation, and under the elastic force of the first reset member 72, the engaging tooth can be automatically guided into the engaging groove through the rounded edges 7111 on both sides.

In an embodiment, as shown in FIGS. 12 and 13, the fixing hole 31 is provided with a first limiting portion 32, and the locking member 71 is provided with a second limiting portion 713. The second limiting portion 713 can abut against the first limiting portion 32 to limit the locking member 71 from moving in the direction away from the movable part 4 to be disengaged from the fixed base 3. When the locking member 71 is disposed at the unlocked position, the first limiting portion 32 and the second limiting portion 713 are separated from each other. When the locking member 71 is disposed at the locked position, the first limiting portion 32 abuts against the second limiting portion 713. Specifically, as shown in FIG. 13, end surfaces of the engaging teeth are formed into the second limiting portion 713. In this embodiment, the first limiting portion 32 and the second limiting portion 713 may not be provided, and at least some of the engaging teeth may move outside the fixing hole 31.

In other embodiments, the first limiting portion 32 and the second limiting portion 713 may not be provided. For example, the outer circumferential surface 716 of the locking member 71 or the inner circumferential surface (i.e., inner wall) 313 of the fixing hole 31 is formed as a truncated cone side surface with the rotating axis 61 as the axial direction. That is, the outer circumferential surface 716 of the locking member 71 or the inner circumferential surface 313 of the fixing hole 31 has a cross section in the shape of a circle, and the diameter of the circle gradually decreases or increases along the extending direction of the rotating shaft 61. The movement of the locking member 71 in the direction away from the movable part 4 can be limited by the outer circumferential surface 716 of the locking member 71 abutting against the inner circumferential surface 313 of the fixing hole 31.

Further, as shown in FIGS. 6 and 8, the first reset member 72 may be arranged between the fixed base 3 and the locking member 71 or between the movable part 4 and the locking member 71. The first reset member 72 bias the locking member 71 toward the locked position. In this embodiment, the first reset member 72 is sleeved on the driving member 75, and the two ends of the first reset member 72 abut against the fixed base 3 and the locking member 71 respectively. The first reset member 72 may include an elastic member such as a spring or a resilient piece. When the movable part 4 is moved to the desired position, the locking member 71 can automatically move from the unlocked position to the locked position under the elastic force of the first return member 72, thereby limiting the rotation of the gear 62 relative to the rack 42, so that the position of gear 62 relative to rack 42 remains unchanged.

In this embodiment, as shown in FIGS. 6 and 8, taking the locking unit 7 positioned on one side of the movable part 4 as an example, the locking member 71 can be moved from the locked position to the unlocked position by pressing the operating portion 712 in the direction approaching the movable part 4, that is, in the F1 direction. As a result, the first engaging portion 711 and the second engaging portion 311 are switched from a state where the first engaging portion 711 and the second engaging portion 311 are engaged with each other to a state where the first engaging portion 711 and the second engaging portion 311 are separated from each other. Rotating the operating portion 712 while maintaining the pressing force on the operating portion 712 can drive the gear 62 to rotate on the rack 42 through the rotating shaft 61, thereby adjusting the relative position between the movable part 4 and the fixed base 3, as shown in FIGS. 9 and 10.

When the movable part 4 is moved to the desired position, the pressing force is removed, and the locking member 71 moves from the unlocked position to the locked position in a reverse direction of the F1 direction under the action of the first reset member 72, thereby locking the movable part 4 in the desired position. In this embodiment, by pressing and rotating the operating portion 712 simultaneously, the gear 62 is driven to rotate on the rack 42. To facilitate operation, when the locking member 71 is pressed to the unlocked position, at least a part of the operating portion 712 still extends out of the fixing hole 31.

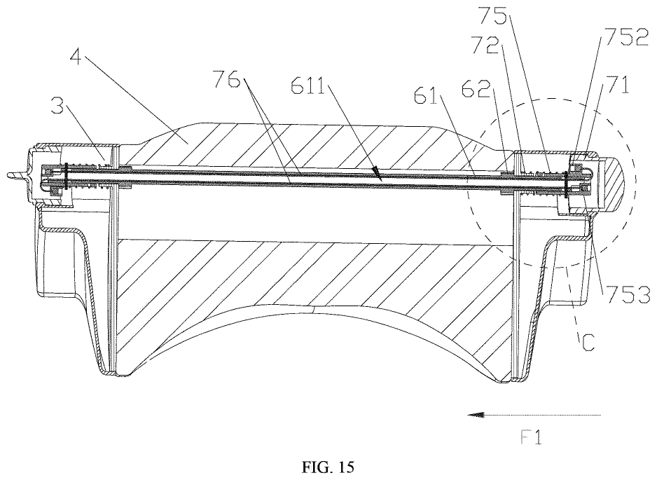

In this embodiment, by simultaneously pressing and rotating the operating portion 712 of the locking members 71 connected to both ends of the rotating shaft with both hands, the synchronous movement of the movable part 4 relative to the fixed bases on both sides can be realized. As shown in FIGS. 15 to 17, the locking unit 7 may further include a driving rope 76. Optionally, the driving rope 76 may be a rigid or flexible rope such as a steel rope, a hemp rope, or a carbon fiber rope. In addition, the rotating shaft 61 is provided with a first mounting cavity 611. The first mounting cavity 611 is arranged in the axial direction of the rotating shaft 61 and extends through both ends of the rotating shaft 61. The driving member 75 is connected to the locking member 71, and includes a first driving portion 752 and a second driving portion 753. In this embodiment, the first driving portion 752 is arranged outside the mounting hole 751, and the second driving portion 753 is arranged inside the mounting hole 751.

The configuration of the driving rope 76 will be described in detail below. For ease of description, both sides of the movable part 4 are defined as a first side and a second side respectively. One end of the driving rope 76 of the locking unit 7 on the first side is connected to the first driving portion 752 of the driving member 75 on the first side. Another end of the driving rope 76 is wrapped around the end of the driving member 75 away from the movable part 4, and then passes through the mounting hole 751 and the first mounting cavity 611 and is connected to the second driving portion 753 of the driving member 75 on the second side. Similarly, the driving rope 76 of the locking unit 7 on the second side is connected to the first driving portion 752 on the second side and the second driving portion 753 on the first side in the same manner.

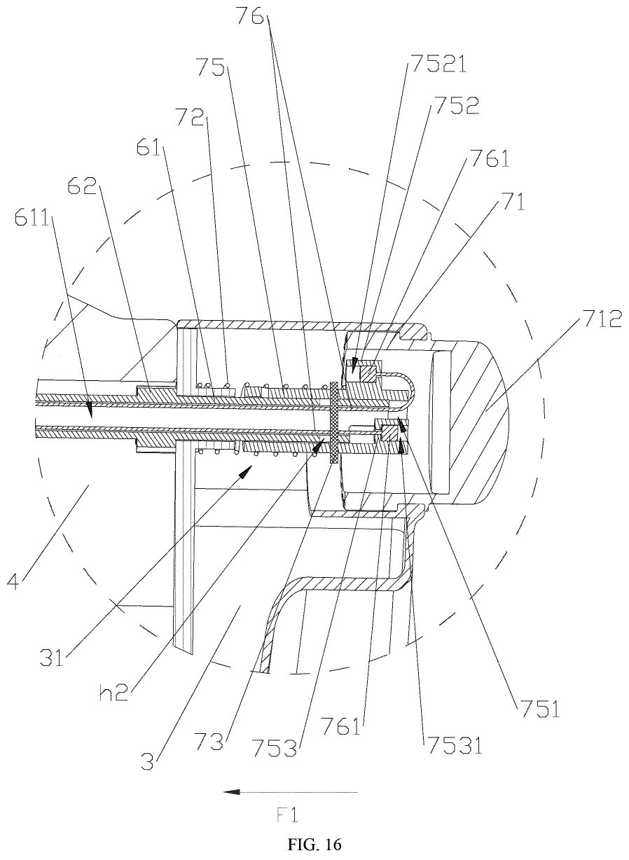

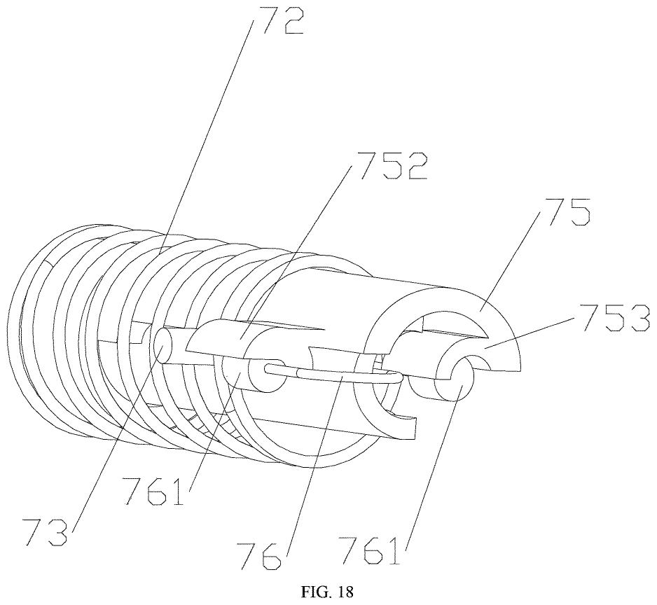

Specifically, as shown in FIGS. 16 and 18, the two ends of the driving rope 76 are provided with engaging members 761 respectively, and the first driving portion 752 and the second driving portion 753 on both sides of the movable part 4 are respectively provided with a first engaging groove 7521 and a second engaging groove 7531. The engaging members 761 at both ends of the driving rope 76 are engaged with the first engaging groove 7521 and the second engaging groove 7531 respectively. In other embodiments, the driving rope 76 may also be connected to the first driving portion 752 and the second driving portion 753 in other ways. But the present disclosure is not limited thereto.

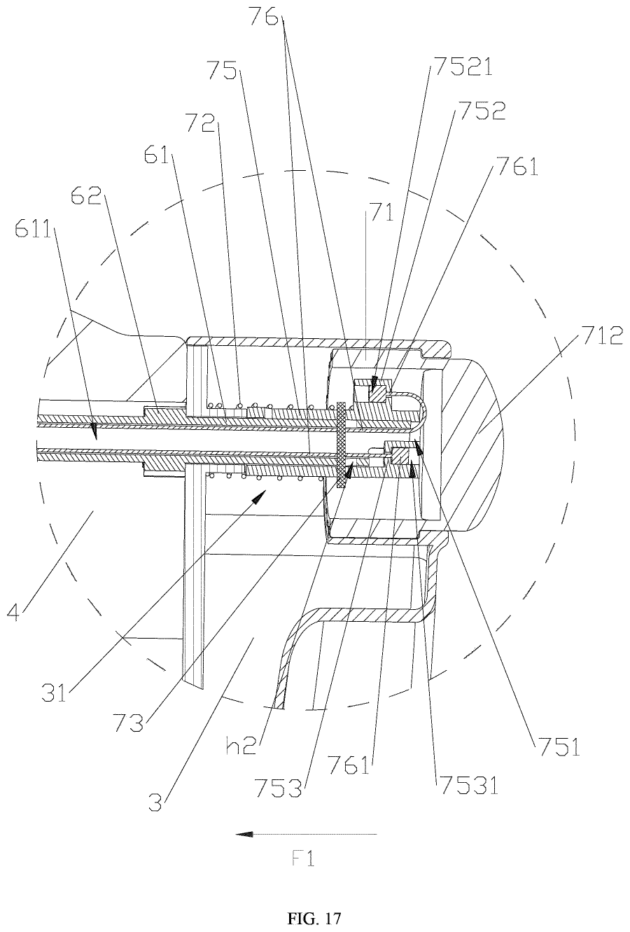

As shown in FIGS. 16 and 17, in this embodiment, when the locking member 71 positioned on the first side of the movable part 4 moves, the driving member 75 on the same side is driven by the locking member 71 to move. At the same time, pulled by the driving rope 76, the driving member 75 positioned on the second side of the movable part 4 moves synchronously away from or close to the movable part 4, so that the locking members 71 on both sides of the movable part 4 can move synchronously close to or away from the movable part 4. Similarly, when the locking member 71 positioned on the second side of the movable part 4 moves, the same technical effect can also be achieved. That is, in the impact shield according to this embodiment, by operating the locking member 71 on either side of the movable part 4, the locking members 71 on both sides of the movable part 4 can be synchronized switched between the unlocked position and the locked position, without synchronously operating the locking members 71 on both sides, making it more convenient for the user to adjust the position of the movable part 4 relative to the fixed base.

In this embodiment, each of the locking units on the first side and the second side is provided with the first reset member. When the locking member 72 is not operated, the locking members 71 on the first side and the second side automatically move from the unlocked position to the locked position under the action of the first reset member, which can further ensure that the locking members 71 on both sides can automatically move from the locked position to the unlocked position. In other embodiments, the first reset member may be arranged only on the locking unit on either the first side or the second side. When the locking member 72 is not operated, the locking member 71 on one of the sides (such as the first side) automatically moves from the unlocked position to the locked position under the action of the first reset member 72. By pulled by the driving rope 76, the locking member 71 on the other side (e.g., the second side) is driven to move from the unlocked position to the locked position, and the locking members 71 on both sides of the movable part 4 can also be reset synchronously.

In other embodiments, the locking unit 7 may also be provided with only one driving rope 76. In this case, only when the locking member 71 on one of the sides (for example, the first side) is operated, the locking member 71 on the second side can be moved synchronously, and while the locking member 71 on the other of the sides (for example, the first side) is operated, the locking member 71 on the first side cannot be moved synchronously.

The working principle of the adjustment mechanism in this embodiment is as follows.

When the operating portion 712 is not pressed, the locking member 71 is disposed at the locked position, the first engaging portion 711 of the locking member 71 is engaged with the second engaging portion 311 on the inner wall 313 of the fixing hole 31, and the rotating shaft 61 is relatively fixed to the fixed base 3, as shown in FIG. 16. If the position of the impact shield 2 is required to be adjusted, the operating portion 712 can be pressed to move the locking member 71 from the locked position to the unlocked position, so that the first engaging portion 711 and the second engaging portion 311 are disengaged from each other, as shown in FIG. 17. At this time, the rotating shaft 61 can rotate relative to the fixed base 3. While pressing the operating portion 712, rotating the operating portion 712 can enable the rotating shaft 61 to rotate in synchronization with the operating portion 712 to drive the gear 62 to rotate on the rack 42, thereby enabling the movable part 4 to move relative to the fixed base 3. When the movable part 4 moves to the desired position, the pressing force on the operating portion 712 is removed, and the locking member 71 moves from the unlocked position to the locked position under the elastic force of the first reset member 72, thereby locking the movable part 4 in the desired position.

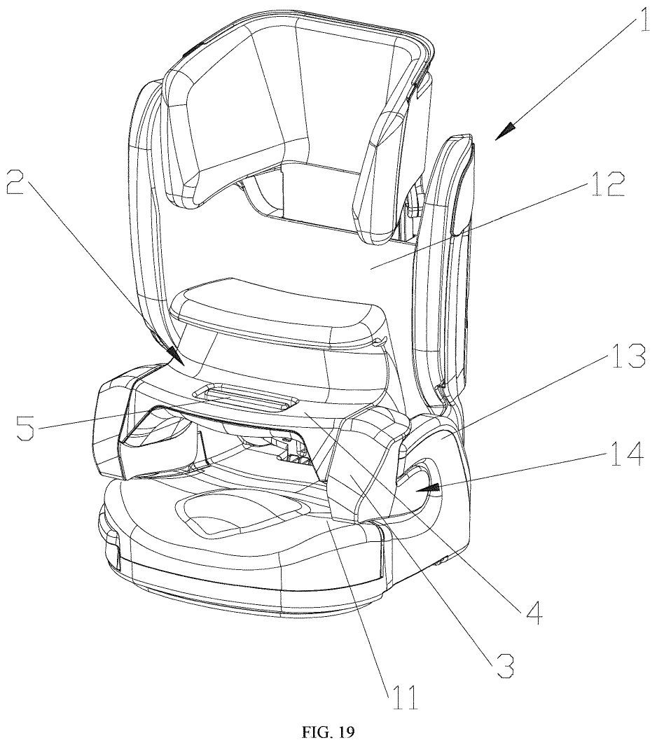

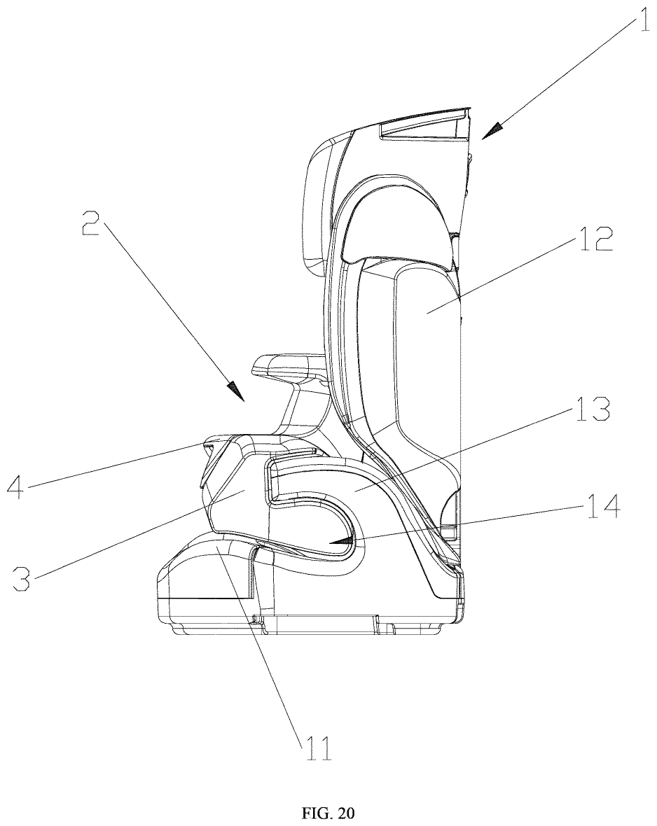

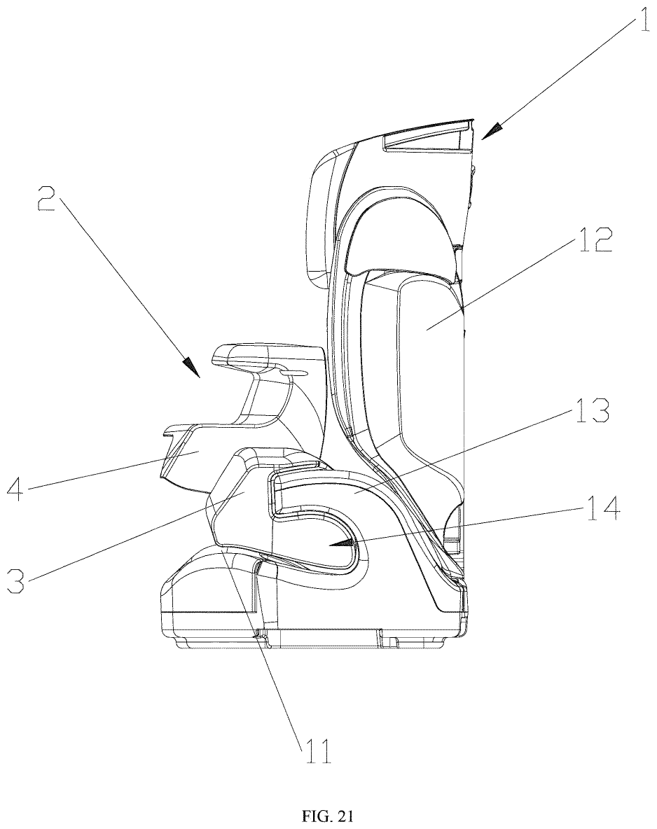

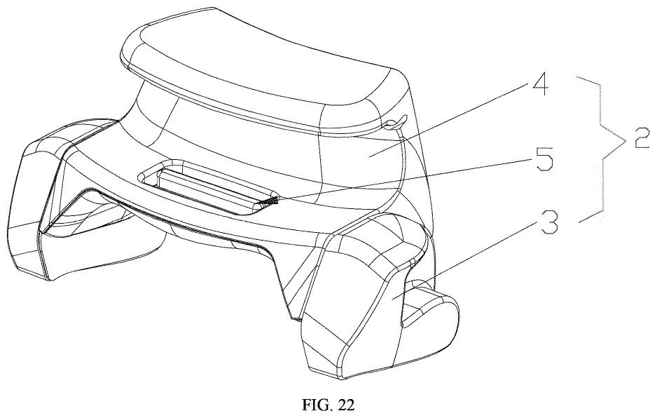

As shown in FIGS. 19 to 21, a second embodiment of the present disclosure also provides a safety seat, which includes a seat body 1 and an impact shield 2. The seat body 1 of this safety seat has the same configuration as that of the safety seat in the first embodiment. As shown in FIGS. 21 and 22, the impact shield 2 in this embodiment also includes a fixed base 3, a movable part 4, and an adjustment mechanism 5. The movable part 4 in this embodiment has the same configuration as that of the movable part 4 in the first embodiment. The difference between the impact shield 2 in this embodiment and the impact shield 2 in the first embodiment lies in the configurations of the fixed base 3 and the adjustment mechanism 5.

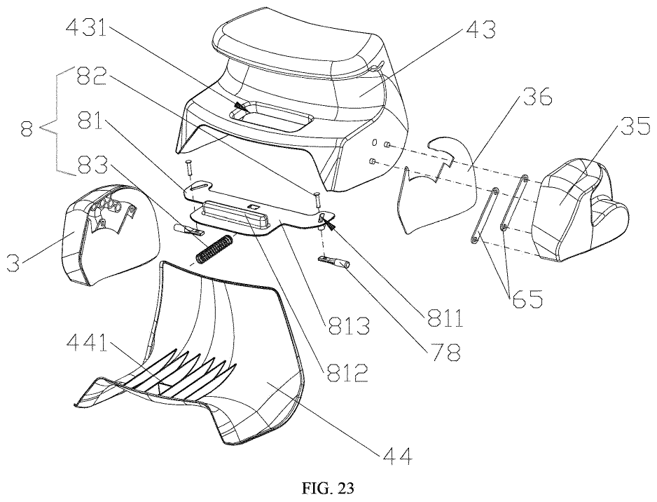

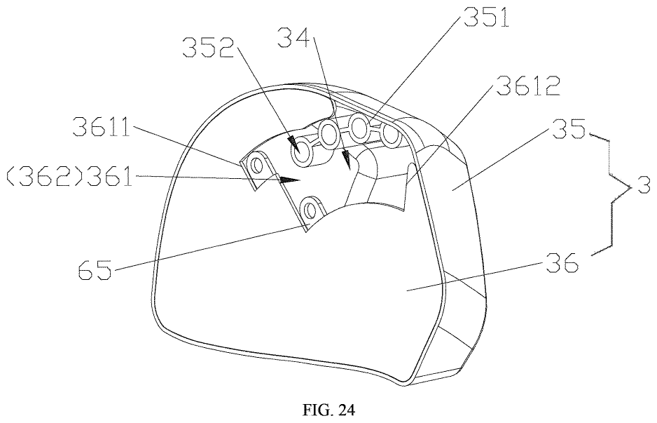

As shown in FIGS. 23 and 24, the fixed base 3 includes a first housing 35 and a second housing 36 facing the movable part 4. The first housing 35 and the second housing 36 enclose a receiving cavity 34. The second housing 36 is provided with a first groove 361 and a second groove 362. In this embodiment, the first groove 361 and the second groove 362 overlap. In other embodiments, the first groove 361 and the second groove 362 may also be spaced apart from each other.

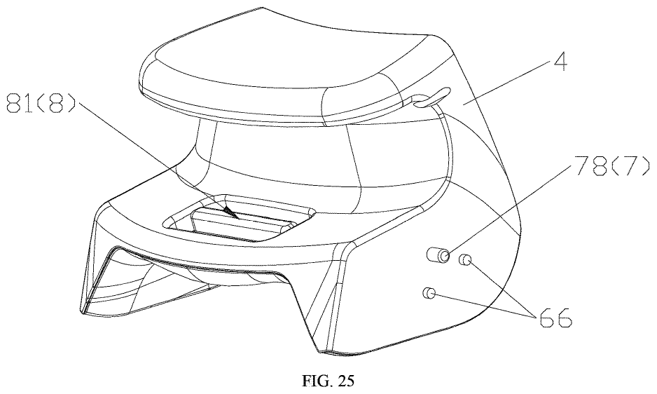

As shown in FIGS. 25 to 27, the adjustment mechanism 5 includes a driving unit 6, a locking unit 7, and an operating unit 8. In this embodiment, the driving unit 6 may be also rotatably connected to the fixed base 3 to drive the movable part 4 to move between a first position and a second position. A rotation axis of the driving unit 6 intersects with a moving direction of the movable part 4.

The driving unit 6 includes a driving rod 65, a second pin shaft 66, and a third pin shaft 67. The driving rod 65 is arranged in the receiving cavity 34, to reduce a gap between the movable part 4 and the fixed base 3, which prevent a sandwich trap. In other embodiments, the driving rod 65 may be also be arranged between the fixed base 3 and the movable part 4. An end of the second pin shaft 66 is fastened to the movable part 4, and another end of the second pin shaft 66 is pivotally connected to the driving rod 65 through the first groove 361. The first groove 361 has a first groove wall 3611 and a second groove wall 3612. The second pin shaft 66 can move along the first groove 361 and abut against the first groove wall 3611 or the second groove wall 3612 to limit the rotation range of the driving rod 65, so that the rotation of the driving rod 65 is limited between the first groove wall 3611 and the second groove wall 3612. In addition, the third pin shaft 67 is arranged on the second housing 36, and the driving rod 65 is pivotally connected to the second housing 36 through the third pin shaft 67.

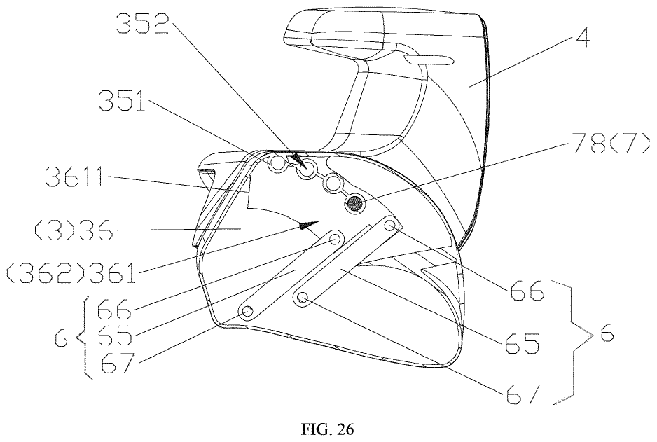

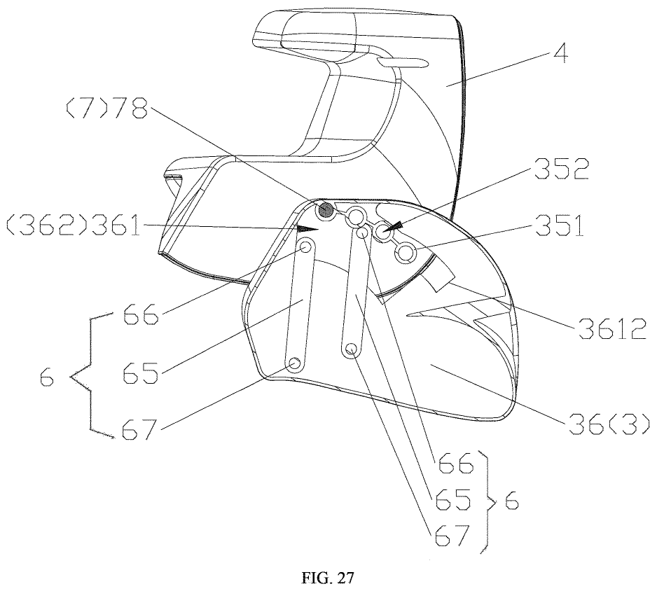

In this embodiment, two driving rods 6 5 are arranged on at least one of the sides of the fixed base 3 to guide the movement of the movable part 4. An end of each of the driving rods 65 is pivotally connected to the second housing 36 of the fixed base 3 through the third pin shaft 67, and another end of each of the driving rods 65 is pivotally connected to the movable part 4 through the second pin shaft 66, so that the movable part 4 can move more stably, which prevents the movable part 4 from leaning forward or backward when moving. The two driving rods 65 may have the same length or different lengths. In this embodiment, as shown in FIGS. 26 and 27, the two driving rods 65 have the same lengths, and the extending directions of the two driving rods 65 are generally parallel to each other, so that the two driving rods 65 rotate synchronously, and the movable part 4 moves more smoothly. When the movable part 4 moves, the rotation angles of the two driving rods 65 are substantially the same. Accordingly, through the relative rotation between the driving unit 6 and the fixed base 3, the movable part 4 can be driven to move between at least the first position and the second position.

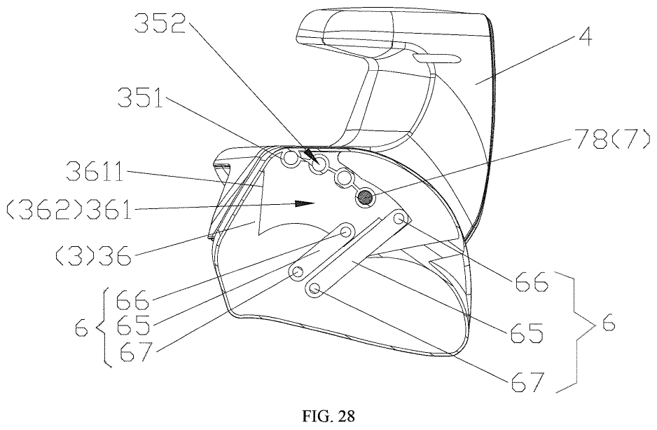

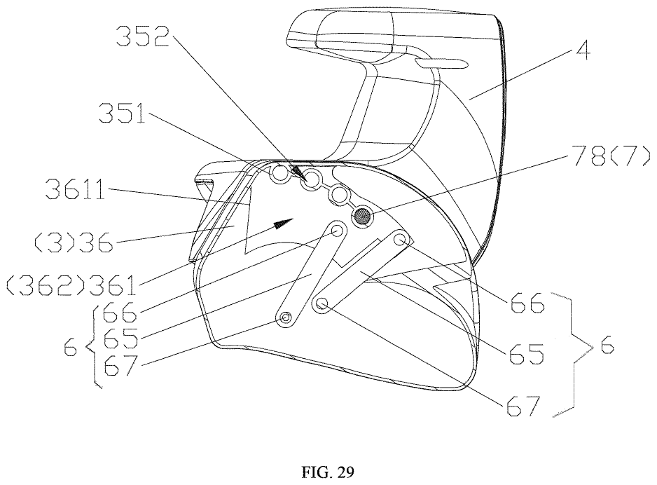

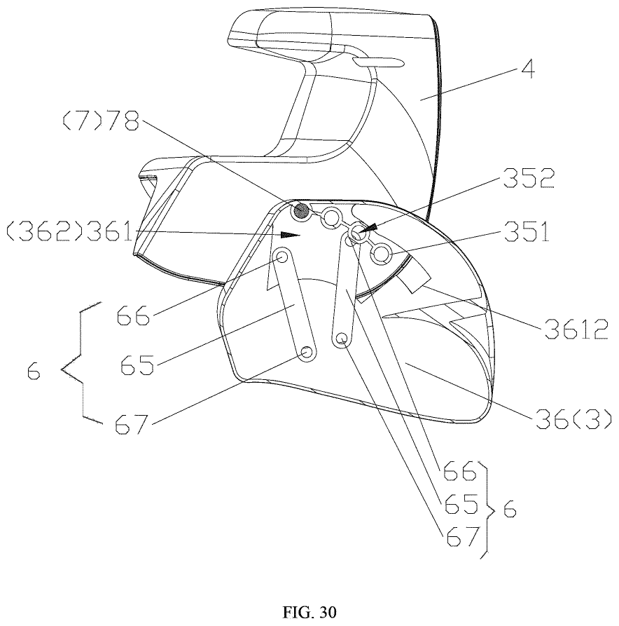

In another embodiment, as shown in FIG. 28, the two driving rods 65 may also have different lengths. In yet another embodiment, as shown in FIGS. 29 and 30, the extending directions of the two driving rods 65 may also intersect. For example, the distance between the two third pin shafts 67 is different from the distance between the two second pin shafts 66, so that the extending directions of the two driving rods 65 are not parallel to each other. In other embodiments, the extending directions of the two driving rods 65 may also intersect, and the two driving rods 65 may have different lengths. In addition, in other embodiments, there may be less than two or more than two driving rods 65.

In this embodiment, as shown in FIGS. 22 and 23, the fixed base 3 and the adjustment mechanism 5 are arranged on each of both sides of the movable part 4. The driving rod 65 of each adjustment mechanism 5 is pivotally connected to the movable part 4 and the fixed base 3 on the corresponding side respectively. The driving units 6 on both sides pivot synchronously, so that the movable part 4 moves smoothly. In other embodiments, the fixed base 3 and the adjustment mechanism 5 may be arranged only on one of the sides of the movable part 4.

Specifically, as shown in FIGS. 23 to 24, the locking unit 7 includes a locking pin 78. The locking pin 78 is slidably arranged on the movable part 4. The locking pin 78 has a locked position and an unlocked position. The fixed base 3 is provided with a plurality of positioning holes 352 extending in a direction parallel to the locking pin 78. When the locking pin 78 is disposed at the locked position, the locking pin 78 is inserted into one of the positioning holes 352 to limit the relative movement between the movable part 4 and the fixed base 3. When the locking pin 78 is disposed at the unlocked position, the locking pin 78 is separated from the positioning hole 352 to allow the movable part 4 to move relative to the fixed base 3. In this embodiment, the plurality of positioning holes 352 are arranged along an arcuate path, but the present disclosure is not limited thereto. In other embodiments, by adjusting the number and positions of the second pin shaft 66 and the third pin shaft 67, the plurality of positioning holes 352 may be also arranged along a linear path inclined relative to the seat surface 11. In this embodiment, as shown in FIGS. 23 and 24, a raised portion 351 is arranged in the receiving cavity 34. The raised portion 351 is provided with the plurality of positioning holes 352. When the locking pin 78 is disposed at the locked position, the locking pin 78 extends through the second groove 362 and is inserted into one of the positioning holes 352. The locking pin 78 is inserted and fitted into different positioning holes 352, so that the relative fixation between the movable part 4 and the fixed base 3 can be achieved. The second groove 362 and the first groove 361 are the same groove. In other embodiments, the positioning holes 352 may be directly arranged on the second housing 36 of the fixed base 3. The positioning holes 352 need to be arranged so as to avoid the first groove 361, and there is no need to provide the second groove 362.

As shown in FIG. 23, the operating unit 8 is connected to the locking unit 7. The operating unit 8 may be operated to drive the locking pin 78 to move between the locked position and the unlocked position. Specifically, the operating unit 8 includes an operating member 81, a driving post 82, and a second reset member 83. The operating member 81 is movably arranged on the movable part 4. The driving post 82 is slidably connected to the operating member 81, and fixedly connected to the locking pin 78. The operating member 81 is operable to drive the driving post 82 to move, thereby driving the locking pin 78 to move between the locked position and the unlocked position.

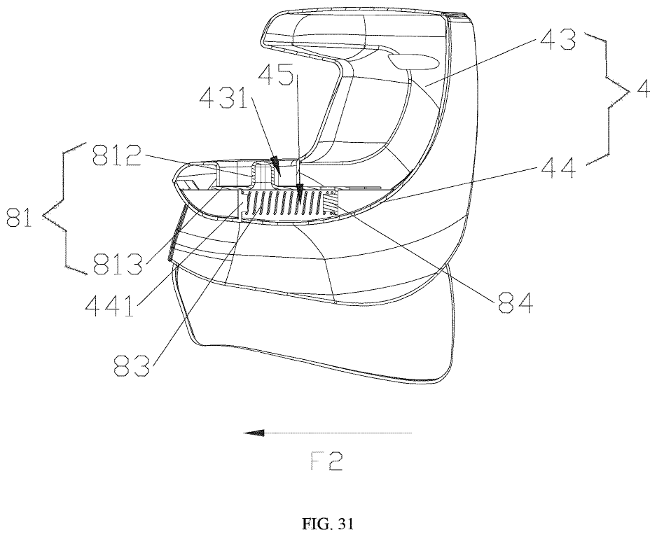

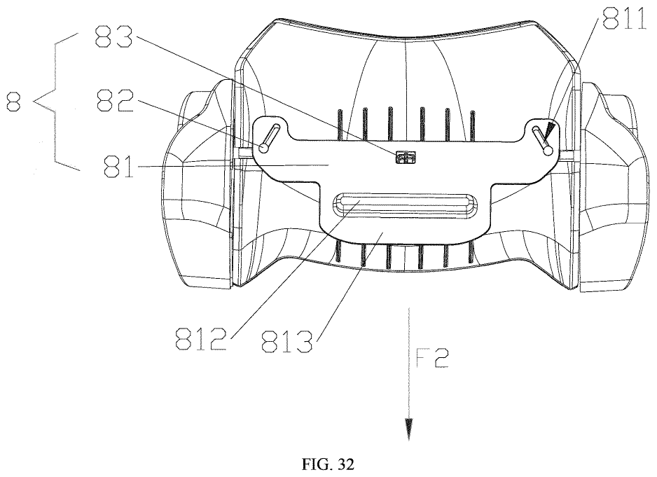

Specifically, as shown in FIG. 23, the operating member 81 is provided with a third strip-shaped hole 811. An extending direction of the third strip-shaped hole 811 intersects with the moving direction of the operating member 81. The driving post 82 is inserted into the third strip-shaped hole 811 and can move along the third strip-shaped hole 811. Referring to FIGS. 31 and 32, the operating member 81 moves in a front-rear direction, that is, moves back and forth along the F2 direction shown in FIGS. 31 and 32. By moving the operating member 81, the driving post 82 moves along the third strip-shaped hole 811, thereby driving the locking pin 78 to move between the locked position and the unlocked position. As shown in FIGS. 31 and 32, the operating member 81 includes a handle portion 812 and a driving portion 813. The driving portion 813 is plate-shaped. The third strip-shaped hole 811 is arranged at left and right ends of the driving portion 813, that is, arranged at ends of the driving portion 813 in a direction perpendicular to the F1 direction. The handle portion 812 protrudes from the substantially middle portion of the driving portion 813, to push the driving member 813 to move.

As shown in FIGS. 23 and 31, the movable part 4 may include a first base 43 and a second base 44. The first base 43 and the second base 44 are engaged with each other to form a second mounting cavity 45. The first base 43 is provided with an operating groove 431. The operating groove 431 is communicated with the second mounting cavity 45. The driving member 813 is inserted in the second mounting cavity 45 and can move in the second mounting cavity 45. The handle portion 812 extends from the second mounting cavity 45 to the outside of the operating groove 431, so that the handle portion 812 can be operated to drive the driving portion 813 to move.

As shown in FIG. 31, the second reset member 83 is arranged in the second mounting cavity 45 and is positioned between the driving member 813 and the second base 44. The movable part 4 is provided with a first abutting portion 441 arranged in the second mounting cavity 45. A second abutting portion 84 is arranged on a surface of the driving portion 813 facing away from the handle portion 812. It can be understood that the second abutting portion 84 may also be arranged in the second mounting cavity 45. In this embodiment, the second abutting portion 84 is arranged at the relative rear side of the first contact portion 441. Both ends of the second reset member 83 abut against the first abutting portion 441 and the second abutting portion 84 respectively. The second reset member 83 biases the operating member 81 toward the initial position of the operating member 81. When the operating member 81 is in the initial position, the movable part 4 is fixed relative to the fixed base 3.

The position adjustment principle of the impact shield 2 according to the second embodiment of the present disclosure is as follows.

When the locking pin 78 is disposed at the locked position where the locking pin 78 is inserted into and fitted into the positioning hole 352, the movable part 4 is fixed relative to the fixed base 3. When it is necessary to adjust the position of the movable part 4, a certain external force is applied to the handle portion 812, so that the operating member 81 moves toward the F2 direction, so that the driving posts 82 at both ends of the driving member 813 move along the third strip-shaped hole 811 and close to each other. As a result, the locking pins 78 on both sides of the movable part 4 are driven to move from the locked position to the unlocked position, that is, the locking pins 78 are disengaged from the positioning holes 352. At this time, the movable part 4 can be moved to the appropriate position through the pivoting of the driving rod 65. Then, the external force applied to the handle portion 812 is removed, and the operating portion 81 moves in the reverse direction of F2 under the action of the second reset part 83, so that the driving posts 82 at both ends of the driving member 813 move away from each other along the third strip-shaped hole 811, thereby driving the locking pins 78 on both sides of the movable part 4 to move from the unlocked position to the locked position.

The safety seat and the impact shield 2 thereof according to the present disclosure have at least the following technical effects.

In the impact shield 2, through the adjustment mechanism 5, it is possible to adjust not only the horizontal distance between the movable part 4 and the backrest 12, but also the vertical distance between the movable part 4 and the seat surface, so that the safety seat has an adjustable seating space, which can better meet the seating needs of children of different body sizes and is convenient for children to use.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

1. An impact shield, applicable to a safety seat, the impact shield comprising:
a fixed base adapted to be connected to a seat body of the safety seat;
a movable part movably connected to the fixed base; and
an adjustment mechanism arranged between the fixed base and the movable part, and configured to adjust a position of the movable part relative to the fixed base.

2. The impact shield according to claim 1, wherein the adjustment mechanism comprises:
a driving unit movably connected to the movable part, and
wherein the driving unit is rotatably connected to the fixed base to drive the movable part to move, and a rotation axis of the driving unit intersects a moving direction of the movable part.

3. The impact shield according to claim 2, wherein the rotation axis of the driving unit is perpendicular to the moving direction of the movable part.

4. The impact shield according to claim 1, wherein the adjustment mechanism comprises:
a driving unit extending through the movable part and comprising a rotating shaft and a gear, and
wherein the gear is fastened to the rotating shaft and arranged coaxially with the rotating shaft, the movable part is provided with a rack configured to be engaged with the gear, and the driving unit is configured to be rotatably connected to the fixed base, so that when the driving unit rotates, the movable part is driven to move relative to the fixed base by the engagement between the gear and the rack.

5. The impact shield according to claim 4, wherein the movable part is provided with a first strip-shaped hole, the rack is arranged on a hole wall of the first strip-shaped hole, and the first strip-shaped hole is configured to allow the gear to rotate in the first strip-shaped hole.

6. The impact shield according to claim 4, wherein the rack is arranged along an arc line or a straight line.

7. The impact shield according to claim 4, wherein the adjustment mechanism comprises a locking unit comprising a locking member, the locking member is engaged with the rotating shaft to rotate in synchronization with the rotating shaft, the locking member is slidable relative to the rotating shaft along a rotation axis of the driving unit, and the locking member is configured to be operable to be selectively disposed at a locked position or an unlocked position along a sliding path, and
wherein when the locking member is disposed at the locked position, the locking member is restricted from rotating, and when the locking member is disposed at the unlocked position, the locking member is allowed to rotate to drive the rotating shaft to rotate synchronously.

8. The impact shield according to claim 4, wherein the adjustment mechanism comprises a locking unit comprising a locking member, the locking member is engaged with the rotating shaft to rotate in synchronization with the rotating shaft, the locking member is slidable relative to the rotating shaft along a rotation axis of the driving unit, and the locking member is configured to be operable to be selectively disposed at a locked position or an unlocked position along a sliding path,
wherein the locking member comprises a first engaging portion, and the fixed base is provided with a second engaging portion adapted to be engaged with the first engaging portion, and
wherein when the locking member is disposed at the locked position, the first engaging portion is engaged with the second engaging portion, and when the locking member is disposed at the unlocked position, the first engaging portion is disengaged from the second engaging portion.

9. (canceled)

10. The impact shield according to claim 4, wherein the adjustment mechanism comprises a locking unit comprising a locking member,
wherein the fixed base is provided with a fixing hole extends therethrough, at least a part of the locking member is received in the fixing hole, and an end of the rotating shaft extends into the fixing hole to be engaged with the locking member, and
wherein the locking member is provided with an engaging tooth, and an inner wall of the fixing hole is provided with an engaging groove configured to be engaged with the engaging tooth, and
wherein the locking member comprises an annular outer circumferential surface, the engaging tooth is arranged on the outer circumferential surface, and the engaging tooth has a rounded edge on both sides in a circumferential direction of the outer circumferential surface.

11-12. (canceled)

13. The impact shield according to claim 4, wherein the adjustment mechanism comprises a locking unit comprising a locking member,
wherein the fixed base is provided with a fixing hole extends therethrough, at least a part of the locking member is received in the fixing hole, and an end of the rotating shaft extends into the fixing hole to be engaged with the locking member, and
wherein at least a part of the locking member is shaped as a regular polygonal cylinder, and at least a part of an inner wall of the fixing hole defines a regular polygonal hole matching the regular polygonal cylinder.

14. The impact shield according to claim 4, wherein the fixed base is provided with a fixing hole extending therethrough, the adjustment mechanism comprises a locking unit comprising a locking member, the locking member is arranged on a first side surface of the fixed base away from the movable part and positioned outside the fixing hole, an end of the rotating shaft extends through the fixing hole to be engaged with the locking member, and the locking member is configured to, when the locking member is disposed at the locked position, abut against or be in snap-fit with the first side surface for locking.

15. (canceled)

16. The impact shield according to claim 4, wherein the adjustment mechanism comprises a locking unit comprising a locking member, the locking member is engaged with the rotating shaft to rotate in synchronization with the rotating shaft, the locking member is slidable relative to the rotating shaft along a rotation axis of the driving unit, and the locking member is configured to be operable to be selectively disposed at a locked position or an unlocked position along a sliding path, and
wherein the locking unit further comprises a first reset member arranged between the fixed base and the locking member or arranged between the movable part and the locking member, and the first reset member is configured to bias the locking member toward the locked position.

17. The impact shield according to claim 4, wherein the adjustment mechanism comprises a locking unit comprising a locking member, a first pin shaft and a driving member fixedly connected to the locking member, the locking member is engaged with the rotating shaft to rotate in synchronization with the rotating shaft, and the locking member is slidable relative to the rotating shaft along a rotation axis of the driving unit, and
wherein one of the rotating shaft and the driving member is provided with a second strip-shaped hole, the other of the rotating shaft and the driving member is fixedly connected to the first pin shaft, and the first pin shaft is inserted into the second strip-shaped hole and movable along the second strip-shaped hole.

18. (canceled)

19. The impact shield according to claim 4, wherein the adjustment mechanism comprises a locking unit comprising a locking member,
wherein the fixed base is provided with a fixing hole extending therethrough, at least a part of the locking member is received in the fixing hole, and an end of the rotating shaft extends into the fixing hole to be movably connected to the locking member, and
wherein an end of the locking member away from the movable part is provided with an operating portion, and at least a part of the operating portion extends out of the fixing hole.

20. (canceled)

21. The impact shield according to claim 4, wherein the adjustment mechanism comprises a locking unit, the locking unit comprising a locking member and a driving rope, the locking member being movably connected to rotating shaft,
wherein both sides of the movable part are provided with the fixed base and the locking unit, and
wherein two ends of the driving rope are connected to the locking members on both sides of the movable part respectively so that the locking members on both sides of the movable part are switchable between a locked position and an unlocked position synchronously.

22. The impact shield according to claim 21, wherein the driving member is provided with a first driving portion and a second driving portion, and
wherein for the locking unit arranged on one of both sides of the movable part, one of the two ends of the driving rope is connected to the first driving portion of the driving member on the one of both sides of the movable part, and the other of the two ends of the driving rope is connected to the second driving portion of the driving member on the other of both sides of the movable part.

23. The impact shield according to claim 21, wherein the driving member is provided with a mounting hole, a first driving portion arranged outside the mounting hole, and a second driving portion arranged in the mounting hole,
wherein an end of the rotating shaft is inserted into the mounting hole, and the rotating shaft is provided with a first mounting cavity extending therethrough,
wherein the driving rope extends though the first mounting cavity and the mounting hole, and
one of the two ends of the driving rope is connected to the first driving portion of the driving member on one of both sides of the movable part, and the other of two ends of the driving rope is connected to the second driving portion of the driving member on the other of both sides of the movable part.

24. The impact shield according to claim 2, wherein the driving unit comprises at least one driving rod pivotally connected to the movable part and the fixed base.

25. (canceled)

26. The impact shield according to claim 24, wherein the driving unit further comprises a second pin shaft,
wherein the fixed base comprises a first housing and a second housing, the second housing faces the movable part, the first housing and the second housing enclose a receiving cavity, the second housing is provided with a first groove, and the at least one driving rod is arranged in the receiving cavity, and
wherein an end of the second pin shaft is fastened to the movable part, and another end of the second pin shaft is pivotally connected to the driving rod through the first groove.

27-35. (canceled)

36. A safety seat, comprising:
a seat body; and
the impact shield according to claim 1,
wherein the impact shield is connected to the seat body through the fixed base.
